(19) United States
(12) Patent Application Publication
(10) Pub. No.: US 2026/0252500 A1
(43) Pub. Date: Aug. 27, 2026

(54) SECURE VIDEO SIGNAL TRANSMISSION AND SWITCHING

(71) Applicant: FIBERNET LTD., Yokneam Illit (IL)

(72) Inventor: Naftali SABAG, Haifa (IL)

(21) Appl. No.: 19/462,338

(22) Filed: Jan. 28, 2026

Related U.S. Application Data
(60) Provisional application No. 63/751,046, filed on Jan. 29, 2025.

(51) Int. Cl. G06F 13/10; G06F 13/38; G06F 13/42

(52) U.S. Cl. CPC G06F 13/10; G06F 13/382; G06F 13/4282; G06F 2213/0042

(57) ABSTRACT

A secure KVM configured to connect to USB-C ports of two or more host computers and to a user console comprising a display and control peripherals; wherein a controller of the KVM device is configured to identify the operational attributes of the display and control peripherals; initiate control of a selected host computer; perform a configuration process of a USB-C connection with the selected host computer based on the identified operational attributes of the display and control peripheral; transmit control commands received from the control peripherals to the selected host computer over the USB-C connection, while enforcing unidirectionality which prevents transmission of data from the selected host computer to the control peripherals; and transmit a video signal received from the selected host computer via the USB-C connection to the display, while enforcing unidirectionality which prevents transmission of data from the display to the selected host computer.

### CROSS-REFERENCE TO RELATED APPLICATIONS

This application claims the benefit of priority from U.S. Provisional Patent Application No. 63/751,046, filed Jan. 29, 2025, entitled “SECURE VIDEO SIGNAL TRANSMISSION AND SWITCHING,” the contents of which are all incorporated by reference as if fully set forth herein in their entirety.

### FIELD OF THE INVENTION

The present invention relates to secure video signal transmission and switching.

### BACKGROUND OF THE INVENTION

A keyboard, video and mouse (KVM) switch is a hardware device which allows a user to control two or more host computers from a single user console comprising a display monitor and computer peripherals (e.g., keyboard mouse).

However, this capability can raise security challenges, because shared displays and peripherals may be targets for malicious attacks which attempt to cause data leakage between different host computers controlled via the single user console comprising keyboard, mouse and display.

One possible solution is to enforce unidirectionality of data transmission between the user console and each of the host computers, thus minimizing the risk of data leakage between different host computers. However, one of the challenges is the fact that different display monitors may require different video transmission settings to enable optimal operation of the display when connected to different host computers. Thus, connecting a display to a host computer typically requires transmitting EDID settings data in the opposite direction to the video stream, i.e., from the display to the computer, to enable the host computer to adjust its video stream output to the monitor's settings. The transmission of EDID settings tables from the display monitor to the host computer thus requires at least some bi-directional data transmission between the shared user console and the multiple host computers.

This reality presents a risk in that a connected host computer may be hacked and used to transmit malicious code through the bi-directional EDID data line back to the shared display. Then, when the display is switched to another host computer, the data that was maliciously stored on the display may be transferred to a another host computer.

USB Type-C, also referred to as USB-C, is a hardware interface for Universal Serial Bus (USB). On its exterior, the upper side and lower side are identical, so the user can plug the connector into a receiving slot in either direction. Compared to previous USB standards, in addition to faster data transmission, USB-C can also support DisplayPort or similar video protocols, for connecting to high definition display screens and high quality audio speakers, to output high quality video and audio signals. Because a single USB-C cable can transmit both data and video and audio signals, and the transmission speed and quality are both superior to previous standards, USB-C related applications are being rapidly developed in relevant industries.

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

The following embodiments and aspects thereof are described and illustrated in conjunction with systems, tools and methods which are meant to be exemplary and illustrative, not limiting in scope.

There is provided, in an embodiment, a secure KVM device, comprising: two or more USB-C interfaces configured to connect to respective USB-C ports of two or more host computers; a device interface configured to connect to a user console comprising a display and control peripherals; and a controller, wherein the controller is configured to identify the operational attributes of the display and control peripherals, wherein the controller is configured to initiate, based on user selection, control by the user console of a selected host computer of the two or more host computers, wherein the controller is configured to perform a configuration process of a USB-C connection with the selected host computer, to determine operational parameters of the USB-C connection, based, at least in part, on the identified operational attributes of the display and control peripherals, wherein based, at least in part, on the configuration process, the KVM device is configured to transmit control commands received from the control peripherals via the device interface, to the selected host computer over the USB-C connection, while enforcing unidirectionality which prevents transmission of data from the selected host computer to the control peripherals, and wherein based, at least in part, on the configuration process, the KVM device is configured to transmit a video signal received from the selected host computer via the USB-C connection, to the display via the device interface, while enforcing unidirectionality which prevents transmission of data from the display to the selected host computer.

In some embodiments, the KVM device is configured to simulate the display and control peripherals to the selected host computer, based, at least in part, on the identified operational attributes of the display and control peripherals.

In some embodiments, the configuration process of the USB-C connection configures the USB-C connection to handle at least the following protocols simultaneously: (i) DisplayPort Alt Mode protocol for the transmitting of the video signal from the selected host computer to the display, and (ii) USB data channels for the transmitting of the control commands from the control peripherals to the selected host computer.

In some embodiments, the configuration process of the USB-C connection comprises at least: (i) connection detection and determination of USB-C connector orientation, (ii) power delivery protocol negotiation with respect to power requirements, and (iii) USB-C Alternate Mode negotiation including DisplayPort settings and data lanes configuration.

In some embodiments, the DisplayPort settings comprise Extended Display Identification Data (EDID) information of the display, comprising resolution, refresh rates, color depth, and/or supported timing.

In some embodiments, the control peripherals comprise at least a keyboard and a pointing device.

In some embodiments, the KVM device further comprises a memory storage, wherein the controller is configured to store the identified operational attributes of the display and control peripherals in the memory storage.

In some embodiments, the user console further comprises an audio device, wherein the KVM device is configured to transmit an audio signal received from the selected host computer over the USB-C connection, to the audio device via the device interface, while enforcing unidirectionality which prevents transmission of data from the audio device to the selected host computer.

In some embodiments, the device interface comprises at least a video interface and one control peripheral interface.

In some embodiments, the user console is connected to the KVM device via an extender comprising a downstream data channel for the video signal and an upstream data channel for the control commands.

There is also provided, in an embodiment, a method comprising: providing a secure KVM device comprising two or more USB-C interfaces configured to connect to respective USB-C ports of two or more host computers, a device interface configured to connect to a user console comprising a display and control peripherals, and a controller; connecting the two or more USB-C interfaces to the respective USB-C ports of the two or more host computers; connecting the user console to the device interface; identifying, by the controller, operational attributes of the display and control peripherals; initiating, by the controller, based on user selection, control by the user console of a selected host computer of the two or more host computers; performing, by the controller, a configuration process of a USB-C connection with the selected host computer, to determine operational parameters of the USB-C connection, based, at least in part, on the identified operational attributes of the display and control peripherals; transmitting by the KVM device control commands received from the control peripherals via the device interface, to the selected host computer over the USB-C connection, while enforcing unidirectionality which prevents transmission of data from the selected host computer to the control peripherals; and transmitting by the KVM device a video signal received from the selected host computer via the USB-C connection, to the display via the device interface, while enforcing unidirectionality which prevents transmission of data from the display to the selected host computer.

In some embodiments, the KVM device is configured to simulate the display and control peripherals to the selected host computer, based, at least in part, on the identified operational attributes of the display and control peripherals.

In some embodiments, the configuration process of the USB-C connection configures the USB-C connection to handle at least the following protocols simultaneously: (i) DisplayPort Alt Mode protocol for the transmitting of the video signal from the selected host computer to the display, and (ii) USB data channels for the transmitting of the control commands from the control peripherals to the selected host computer.

In some embodiments, the configuration process of the USB-C connection comprises at least: (i) connection detection and determination of USB-C connector orientation, (ii) power delivery protocol negotiation with respect to power requirements, and (iii) USB-C Alternate Mode negotiation including DisplayPort settings and data lanes configuration.

In some embodiments, the DisplayPort settings comprise Extended Display Identification Data (EDID) information of the display, comprising resolution, refresh rates, color depth, and/or supported timing.

In some embodiments, the control peripherals comprise at least a keyboard and a pointing device.

In some embodiments, the KVM device further comprises a memory storage, and the method further comprises storing, buy the controller, the identified operational attributes of the display and control peripherals in the memory storage.

In some embodiments, the user console further comprises an audio device, and the method further comprises transmitting by the KVM device an audio signal received from the selected host computer over the USB-C connection, to the audio device via the device interface, while enforcing unidirectionality which prevents transmission of data from the audio device to the selected host computer.

In some embodiments, the device interface comprises at least a video interface and one control peripheral interface, the method further comprising connecting the display to the video interface and connecting at least a first one of the control peripherals to the control peripheral interface.

In some embodiments, the user console is connected to the KVM device via an extender comprising a downstream data channel for the video signal and an upstream data channel for the control commands, and the method further comprises connecting the display and the control peripherals to the extender.

In addition to the exemplary aspects and embodiments described above, further aspects and embodiments will become apparent by reference to the figures and by study of the following detailed description.

### BRIEF DESCRIPTION OF THE DRAWINGS

The present invention will be understood and appreciated more comprehensively from the following detailed description taken in conjunction with the appended drawings in which:

FIG. 1 shows a typical bi-directional video data connection between a video source and a display device.

FIG. 2 schematically illustrates an exemplary secure video/audio transmission device according to the present invention, for secure high-speed video and audio data transmission from a source device (such as a host computer) via a USB-C connection, to a sink device (such as a display device) via a video interface connection.

FIGS. 3A-3C are block diagrams of several embodiments of a secure video/audio transmission device, according to some embodiments of the present disclosure.

FIG. 4 illustrates the functional steps in a method for secure transmission of video between a source and one or more display devices over USB-C protocol, according to some embodiments of the present disclosure.

FIGS. 5A-5B are block diagrams of several embodiments of a secure KVM switch, according to some embodiments of the present disclosure.

FIG. 6 illustrates the functional steps in a method for securely selectively controlling two or more host computers from a single user console comprising a keyboard, a pointing device (e.g., a mouse), and a display device (e.g., a display monitor).

### DETAILED DESCRIPTION OF THE INVENTION

In a first aspect of the present invention, disclosed are devices and methods for secure transmission of video and/or audio from a source, such as a host computer, to one or more sink devices, such as a display device (a computer monitor, a video projector, a digital television), or an audio device (speakers, headphones).

As used herein, the term “sink” (also called a data sink, audio sink, video sink, or similar) is a general term in technology and computing that refers to a device or component that mainly receives or consumes data, as opposed to a source device that generates or sends it. Within the context of the present disclosure, a sink device is any device configured for receiving video and/or audio data stream from a source device. Sink devices include, but are not limited to, display monitors, mobile devices, smartphones, laptops, tablets, notebook computers, speakers, headphones, and the like.

In some embodiments, the present invention provides for a secure video/audio transmission device configured to be coupled via a USB-C interface between a source device and one or more sink devices. The source device can be, e.g., a host computer, and the one or more sink devices, can be, e.g., a display monitor of speakers. The secure video/audio transmission device comprises a USB Type-C (also referred to as USB-C) input connection or interface, and one or more device interfaces, such as audio and video interfaces. The device is coupled to the source device through the USB-C interface, and to the one or more sink devices through the device interfaces.

In some embodiments, the present device provides for secure transmission of video and/or audio data from a source device to one or more sink devices, while enforcing unidirectionality of data which prevents transmission of data back, from the one or more sink devices to the source device.

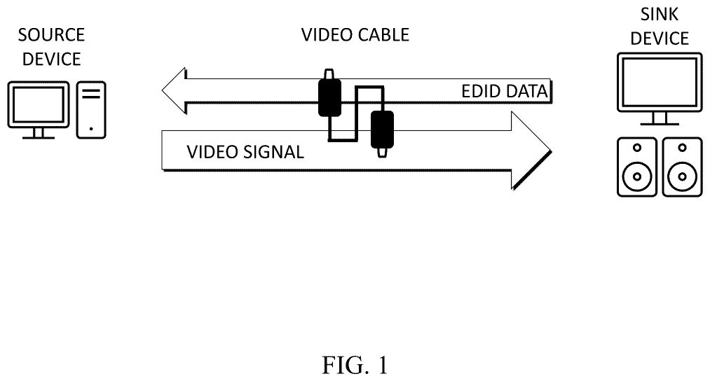

By way of background, in a typical video data connection, a connecting cable (e.g., S-Video, component video, VGA, DVI, HDMI, DisplayPort, Thunderbolt, or the like) between a source and a display device permits bi-directional transmission of data. Thus, video data may be transmitted from the source device to the display, while other data, such as display settings information, may be transmitted back to the source device from the display. Such an arrangement is shown in FIG. 1. In this arrangement, a source device (e.g., a computer as shown) is connected directly to a sink device (display) via a connecting cable. Video data is transmitted to the display, while settings data (using, e.g., the EDID format) is transmitted to the source device. This allows the source device to directly read the display's EDID and adjust parameters of the video transmission accordingly.

As noted above, allowing bi-directional data transmission between a source and a display presents a security risk. For example, a malicious code planted in the display can be transmitted back to the source device and infect it and potentially other devices in a network to which it is connected. To overcome this risk, it is possible to enforce complete unidirectionality of data transmission (i.e., only allowing transmission of video data from source to display) and/or to disconnect some of the lines (such as specified dedicated pins in an HDMI interface) transmitting information back to the source device. However, although this may be advantageous from a security perspective, it may cause operational problems with modern computers and software. Modern computer operating systems and display card drivers typically adjust display resolution to default settings if no display EDID is detected. In some cases, computers may even fail to generate video signals at all.

Similarly, in a typical audio data connection, hardware which is configured to be an audio sink device (such as, for example, loudspeakers, headsets, headphones) may be operated as a microphone and used for eavesdropping purposes. A security issue may arise, for example, when a system is infected with malicious code planted by a hostile entity. Such malicious code may be configured to eavesdrop on the surrounding area of the system, e.g., by monitoring the signal carried back by the audio sink device into an audio device interface. In another example, the malicious code may reconfigure, for example, an audio device interface to which an audio sink is coupled, to operate as a line-in port, wherein the sink device acts as a microphone to eavesdrop on the surrounding area of the system.

As noted above, the USB-C communication protocol allows the transfer of video, audio, data and power over a single cable between devices. USB-C Alt Mode for video and audio allows a USB-C port to transmit DisplayPort, Thunderbolt, HDMI, or other video signals directly through the USB-C cable, alongside or instead of USB data. This can be performed by dynamically reconfiguring some or all of the USB-C four high-speed differential pair data channels to carry video protocol signals. For example, two channels high-speed data channels can be allocated for video and the other two for USB data, to allow for simultaneous video and high-speed data transmission. Alternatively, all four high-speed data channels can be dedicated to DisplayPort, to provide for maximum video bandwidth alongside slower USB data transmission. The USB-C port detects when an Alt Mode-capable device connects and negotiates which mode to use through the USB Power Delivery (USB-PD) protocol. Audio can be embedded within the DisplayPort stream, wherein the video source encodes audio packets into the DisplayPort data stream, and the sink device (monitor, TV, dock) extracts and outputs the audio. Alternatively, audio signal can be transmitted alongside the main video (which may also carry embedded audio) and data paths, using the USB-C also has two sideband use (SBU) pins that can carry analog audio signals. This can implement a dedicated analog audio path separate from the digital Alt Mode traffic.

Handling of display monitor settings data (EDID) in USB-C Alt Mode essentially works similarly to traditional direct video connection. Thus, when a display is connected, the source device queries the sink device's capabilities via a dedicated bi-directional channel (such as the DisplayPort AUX channel) , to retrieve the EDID data, including supported resolutions and refresh rates, color depth capabilities, audio formats, and timing parameters. However, this can create a bi-directional data path that can pose security risks, where a display can send data back to the computer via the USB-C connection.

Accordingly, in some embodiments, the present secure video/audio transmission device provides for EDID interception and emulation, wherein any return data path between the source and the sink is eliminated, and only essential handshaking signals are emulated by the present device with respect to the source. This blocks any pass-through or direct communications from the sink device back to the source device, eliminates potential firmware exploits via display communication, and prevents any inadvertent data transmission back through the video interface. In some embodiments, the present device comprises a unidirectional component or circuit (e.g., a diode, or a fiber-optic connection) configured to enforce unidirectionality of data transmission only from the source to the sink device. In some embodiments, the present device provides for EDID emulation using a firmware solution which caches an EDID profile receives from the sink and provides a corresponding emulated EDID to source. In other cases, the present device may provide for stored pre-programmed EDID display settings.

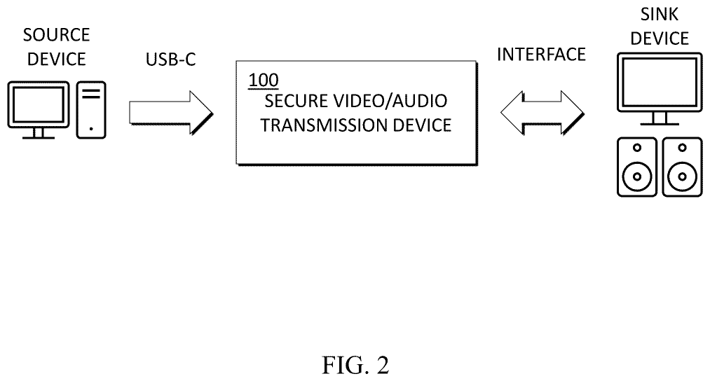

FIG. 2 schematically illustrates an exemplary secure video/audio transmission device 100 according to the present invention. In some embodiments, device 100 provides for secure high-speed video and audio data transmission from a source (such as a host computer) via a USB-C connection, to a sink (such as a display device and/or speakers). In some embodiments, device 100 provides for secure transmission of video/audio from a source to one or more sink devices, while enforcing unidirectionality of data which prevents transmission of data back, from the one or more sink devices to the source device.

In some embodiments, device 100 provides for transmission of high-quality video signals unidirectionally from the source to the sink using the DisplayPort protocol carried over USB-C. This ensures low-latency, high-bandwidth transmission without compression or degradation. In some embodiments, device 100 provides for ensuring that video data (as well as any embedded audio) can only move from source to sink, while no reverse path exists for video or other signals to transmit from the sink to the source, thereby preventing the display from sending back any data or exploits.

In some embodiments, device 100 is capable of detecting EDID settings of the source, and communicating the EDID settings to the source (host computer). EDID is a data structure provided by a display device to describe its capabilities, including supported resolutions, refresh rates, color formats, audio features, and timing parameters.

Typically, the host computer queries the display for this data via the DDC (Display Data Channel) over the video cable. However, in the present case, device 100 acts as an intermediary between the host computer and display, which stores on an onboard memory common EDID profiles. The memory of device 100 can store default EDID settings, captured EDID data from an actual display, or custom-programmed settings.

Device 100 then intercepts the EDID query from the host, and responds with EDID data from its memory storage, to emulate the expected response from the display. Thus, for example, upon initial connection, device 100 may read the EDID from the display via the HDMI or equivalent connection. In some embodiments, this process may be a one-time EDID capture process performed upon initial connection. In some embodiments, device 100 may include a physical user-operated button configured to initiate the one-time acquisition of the EDID. Device 100 then parses and validates the EDID data and stores in in memory. When queried by a host computer, device 100 emulates the EDID data to the host computer. This allows the host computer to configure the video output optimally without direct, ongoing access to the EDID channel of the display. In some embodiments, after the initial EDID capture, the relevant connection pins may be disconnected or isolated, to prevent further reads or writes.

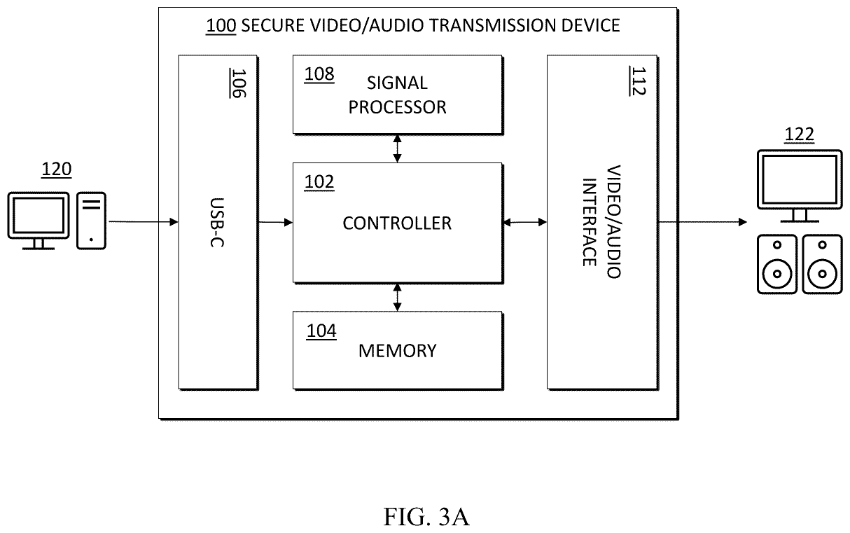

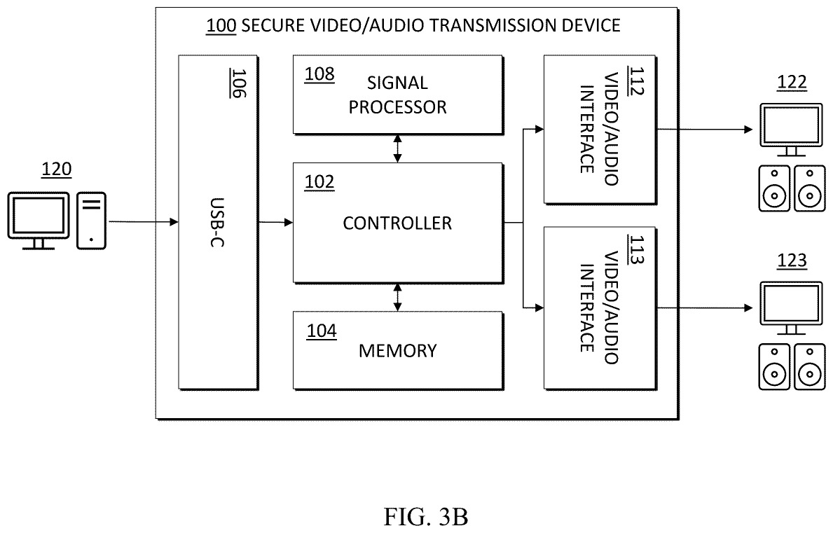

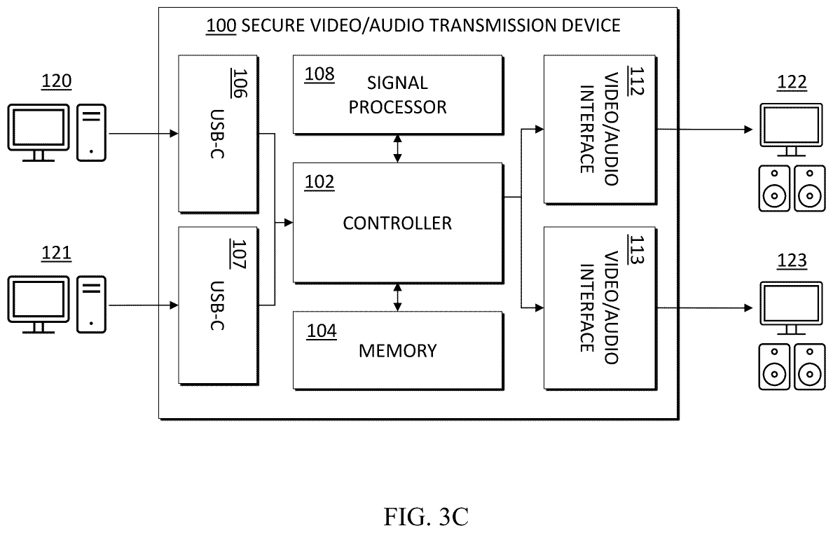

FIG. 3A is a block diagram of an exemplary secure video/audio transmission device 100. As shown in FIG. 3A, device 100 in this embodiment is coupled between a source device 120 (such as a host computer) via a USB-C connection, and a sink device 122 (such as a display monitor and/or speakers) via any suitable interface connection (such as an HDMI port).

Device 100 as described herein is only an exemplary embodiment of the present invention, and in practice may be implemented in hardware only or a combination of both hardware and software. Device 100 is described herein for illustrative purposes with an exemplary set of modules and components performing various functionalities within device 100. However, in practice, device 100 may have more or fewer components and modules than shown, may combine two or more of the components or modules, or may have a different configuration or arrangement of the components or modules. Device 100 may include any additional component enabling it to function such as a motherboard, data busses, power supply, a network interface card, etc. (not shown).

Device 100 may be a dongle, e.g., a small computer hardware item that connects directly at one end to a port on a computing device, such as a USB-C port of a source 120. In the dongle configuration, device 100 may then connect at another end to the sink device 122 via a suitable connecting cable, such as an HDMI cable. In some cases, device 100 may be integrated into a USB-C interface medium, such as a USB-C cable, for example, device 100 may be integrated in to the cable or one of the end connectors. In other cases, device 100 may be realized as a standalone computer hardware item comprising one or more cases or units, which connects to source 120 via a USB-C cable and to sink device 122 via a suitable connecting cable, such as an HDMI cable. However, other suitable configurations of device 100 may be realized, as is known in the art.

In some embodiments, device 100 may receive power for its operation from the source device (e.g., a host computer), via the USB-C connection. In other cases, device 100 may be powered independently of the source device, e.g., using a standard wall outlet. In some embodiments, device 100 may be battery-powered by a rechargeable battery which may be recharged via the USB-C connection to the source device.

Device 100 provides a secure video/audio transmitter designed for high-security environments (e.g., government, military, or corporate settings) to prevent potential data exfiltration or attacks via infected sink devices, while still enabling essential video output and display configuration. Device 100 acts as an inline intermediary between a host computer (e.g., laptop or desktop with USB-C video output support) and a sink device (e.g., monitor with USB-C, HDMI, or DP input).

In some embodiments, device 100 may store in memory 104 software instructions or components configured to operate device 100. The software instructions may be any executable code, e.g., a software application, a program, a process, task or script. In some embodiments, the software instructions may include an operating system, including various software components and/or drivers for controlling and managing general system tasks (e.g., memory management, storage device control, power management, etc.) and facilitating communication between various hardware and software components.

In the exemplary configuration described herein, device 100 includes a controller 102; a memory 104, which may comprise a read-only erasable and programable memory (EEPROM) unit; at least one USB Type-C interface 106; a signal processor 108 which may be or may comprise a video converter (such as a DisplayPort-to-HDMI or similar converter); and at least one device interface, such as interface 112 connectable to sink device 122.

Controller 102 serves as the central processing and coordination hub of device 100 and controls the operation of device 100. Controller 102 is operationally connected to and acts as the primary interface between all hardware and software components of device 102, including memory 104, USB-C interface 106, signal processor 108, and sink interface 112. Controller 102 may receive and process inputs from multiple sources, including USB-C 106 interface and sink interface 112. Controller 102 manages the complete data flow throughout device 100 and acts as an internal switching module which routes and manages data flow between the other modules and components.

In some embodiments, controller 102 is connected to and receives at least one or more of the following channels of USB-C interface 106:
High-speed data channels transmitted over transmitter (TX) and receiver (RX) differential pairs, TX1/RX1 and/or TX2/RX2 lines, which form unidirectional, high-bandwidth channels used to transport video and audio signals.
Data lines D+and D− which carry differential signals for lower-speed USB 2.0 data, such as like keyboards and mouse.
Configuration channels CC1/CC2, used to detect connection orientation in relation to the USB-C port, power delivery, and channel configuration.
Sideband use channel that transmits the sideband use channel signals SBU1/SBU2, which enable multi-purpose alternate modes (alt-mod) supported by the USB-C protocol.

Memory 504 may comprise a read-only erasable and programable memory (EEPROM) unit.

USB-C interface 106 is connectable to a USB-C port of any suitable device, such as source device 120, directly or via any suitable connecting means, such as a USB-C cable. In some embodiments, USB-C interface 106 includes a USB hub and/or controller which manages the operation of USB-C interfaces 106.

In some embodiments, interface 112 may be a USB-C port, a DisplayPort interface, a Thunderbolt interface, an HDMI (High-Definition Multimedia interface) interface, or any other suitable or desirable video interface.

In some embodiments, device 100, e.g., via controller 102, is configured to perform the USB-C handshake process between source 120 and sink 122, to facilitate one-way data transmission, including secure video streaming (e.g., using DisplayPort over USB-C Alt Mode) from source 120 to sink 122. In some embodiments, device 100 is configured to only permit video and audio data transmission from source device 120 to video sink device 122 through device 100, and to prevent any data originating from video display 122 to be transmitted back to source device 120 via device 100, i.e., through interface 112 and USB-C interface 106. Thus, device 100 is configured to block any reverse data flow back to source device 120, to prevent potential security risks like data exfiltration. Device 100 thus acts as a man-in-the-middle which emulates all of the operational attributes of sink 122 (e.g., power requirements, display configuration and settings, etc.) to source 120 during the handshaking process and all protocol interactions.

In some embodiments, upon connection of device 100 to source 120 and sink 122, controller 102 may perform an initial scan to identify the operational attributes of sink 122, including power requirements and display settings. Controller 102 may cache these identified operational attributes of sink 122, e.g., by storing this information on memory 104. Controller 102 may then simulate the power consumption needs of sink 122 to source 120 via a suitable communication to source 120, to ensure that source 120 provides power as if directly connected to sink 122. Controller 102 may then emulate sink 122 to source 120 based on the identified operational attributes of sink 122, to configured the data channels, including the main video channels and sideband use (SBU) pins. Controller 102 may then simulate to source 120 the EDID and related display configuration data of sink 122, including supported resolutions and refresh rates, color depth capabilities, audio formats, and timing parameters. If additional USB data channels are needed (e.g., alongside video), controller 102 may further simulate those to source 120. Once the handshaking process is completed, device 100 may carry unidirectional video/audio data from source 120 to intermediary device 100, which forwards it to sink 122. This process maintains compatibility with USB-C standards while enforcing security.

In some embodiments, device 100 is capable of detecting EDID settings of video sink device 122, and for communicating the EDID settings to the source device 120. For example, upon initial connection, device 100 may read the EDID data from video sink device 122, e.g., via the relevant pins in interface 112. In some embodiments, this process may be a one-time EDID capture process performed upon initial connection. In some embodiments, device 100 may include a physical user-operated button configured to initiate the one-time acquisition of the EDID.

In some embodiments, device 100 then parses and validates the EDID data, and stores it in memory 104. Device 100 may then transmit the EDID data from memory 104 to source device 120. In some embodiments, this allows source device 120 to configure the video output optimally without direct, ongoing access to the EDID channel of video sink device 122.

In some embodiments, after the initial EDID capture, the relevant EDID connection pins in interface 112 may be disconnected, isolated or blocked, to prevent further reads or writes. For example, in some embodiments, controller 102 and/or interface 112 are configured to disconnect, block and/or disable any connection pins or lines which are configured to transmit data from sink device 122 to the source device 120. For example, when interface 112 is an HDMI interface, interface 112 and/or controller 102 are configured to disconnect and/or disable one or more pins within the HDMI interface that are configured to transmit data from sink device 122 to the source device 120. Such lines or pins may include the Display Data Channel (DDC) and/or the Consumer Electronics Control (CEC) channel. In other embodiments, interface 112 is configured to transmit such signals from video display 122 through interface 112 only to controller 102, while ensuring that such signals are not transmitted back to source device 120 through USB-C interface 106. In yet other cases, the connection between interface 112 and controller 102 may comprise a unidirectional component or circuit (e.g., a diode, or a fiber-optic connection) configured to enforce unidirectionality of data transmission only from controller 102 to interface 112, but to disable data transmission in the reverse path.

FIG. 3B is a block diagram of a variation of exemplary secure video/audio transmission device 100, configured to provide secure high-speed video and audio data transmission and switching, between a source device 120 (such as a host computer) via a USB-C connection, and two or more video sink devices via interface connections 112, 113. In the configuration shown in FIG. 3B, device 100 is configured to provide for secure high-speed video and audio data transfer and switching from a source (such as a host computer) via a USB-C connection, to two or more sink devices via interface connections.

FIG. 3C is a block diagram of another variation of exemplary secure video/audio transmission device 100, configured to provide secure high-speed video and audio data transmission and switching, between two or more source devices 120, 121 (such as two host computers) via respective USB-C connections, and two or more video sink devices via interface connections 112, 113. In the configuration shown in FIG. 3C, device 100 is configured to provide for secure high-speed video and audio data transfer and switching from two or more sources (such as a host computers) via USB-C connections, to two or more sink devices via interface connections.

As shown in FIGS. 3B-3C, device 100 in this embodiment is coupled between one or more video source devices 120, 121 (such as a host computer) and two or more sink devices (such as a devices 122, 123).

Device 100 in these embodiments may be a dongle, e.g., a small computer hardware item that connects directly at one end to a port on a computing device, such as a USB-C ports of a one or more sources 120, 121. In the dongle configuration, device 100 may then connect at another end to the two or more sink devices 122, 123 via suitable connecting cables, such as HDMI cables. In some cases, device 100 may be integrated into a USB-C interface medium, such as a USB-C cable, for example, integrated in to the cable or one of the end connectors. In yet other cases, device 100 may be realized as a standalone computer hardware item comprising one or more cases or units, which connects to source devices 120, 121 via a USB-C cable and to two or more sink devices 122, 123 via suitable connecting cables, such as an HDMI cables. However, other suitable configurations of device 10 may be realized, as is known in the art.

In some embodiments, device 100 may receive power for its operation from the video sources (e.g., host computers), via respective USB-C connections. In other cases, device 100 may be powered independently of the source devices, e.g., using a standard wall outlet. In some embodiments, device 100 may be battery-powered by a rechargeable battery which may be recharged via the USB-C connection to the video source.

Device 100 in this example provides a secure video/audio transmitter designed for high-security environments (e.g., government, military, or corporate settings) to prevent potential data exfiltration or attacks via infected sink devices, while still enabling essential video output and display configuration. Device 100 acts as an inline intermediary between one or more host computers (e.g., laptop or desktop with USB-C video output support) and on or more sink devices (e.g., monitor with USB-C, HDMI, or DP input).

In some embodiments, device 100 may store in memory 104 software instructions or components configured to operate device 100. The software instructions may be any executable code, e.g., a software application, a program, a process, task or script. In some embodiments, the software instructions may include an operating system, including various software components and/or drivers for controlling and managing general system tasks (e.g., memory management, storage device control, power management, etc.) and facilitating communication between various hardware and software components.

Device 100 in this configuration includes a controller 102; a memory 104, which may comprise a read-only erasable and programable memory (EEPROM) unit; at least one USB Type-C interface, such as interfaces 106, 107; and a signal processor 108, such as a DisplayPort-to-HDMI (or another interface) converter. Device 100 in these configurations comprises two or more device interfaces, such as interfaces 112, 113 connectable to sink devices 122, 123, respectively.

USB-C interfaces 106, 107 are connectable to a USB-C port of any suitable device, such as source device 120, directly or via any suitable connecting means, such as a USB-C cable. In some embodiments, USB-C interfaces 106, 107 include a USB hub and/or controller which manages the operation of USB-C interfaces 106, 107.

Controller 102 serves as the central processing and coordination hub of device 100 and controls the operation of device 100. Controller 102 is operationally connected to and acts as the primary interface between all hardware and software components of device 102, including memory 104, USB-C interfaces 106, 107, signal processor 108, and sink interfaces 112, 113. Controller 102 may receive and process inputs from multiple sources, including USB-C 106 interface and sink interfaces 112, 113. Controller 102 manages the complete data flow throughout device 100 and acts as an internal switching module which routes and manages data flow between the other modules and components.

In some embodiments, controller 102 is connected to and receives at least one or more of the following channels of USB-C interfaces 106, 107:
High-speed data channels transmitted over transmitter (TX) and receiver (RX) differential pairs, TX1/RX1 and/or TX2/RX2 lines, which form unidirectional, high-bandwidth channels used to transport video and audio signals.
Data lines D+and D-which carry differential signals for lower-speed USB 2.0 data, such as like keyboards and mouse.
Configuration channels CC1/CC2, used to detect connection orientation in relation to the USB-C port, power delivery, and channel configuration.
Sideband use channel that transmits the sideband use channel signals SBU1/SBU2, which enable multi-purpose alternate modes (alt-mod) supported by the USB-C protocol.

In some embodiments, interfaces 112, 113 may be USB-C ports, DisplayPort interfaces, Thunderbolt interfaces, HDMI (High-Definition Multimedia interface) interfaces, or any other suitable or desirable video interface.

In some embodiments, device 100, e.g., via controller 102, is configured to perform the USB-C handshake process between sources 120, 121 and sinks 122, 123, to facilitate one-way data transmission, including secure video streaming (e.g., using DisplayPort over USB-C Alt Mode) from sources 120, 121 to sinks 122, 123. In some embodiments, device 100 is configured to only permit video and audio data transmission from source device 120 to video sink device 122 through device 100, and to prevent any data originating from video display 122 to be transmitted back to source device 120 via device 100, i.e., through interfaces 112, 113 and USB-C interfaces 106, 107. Thus, device 100 is configured to block any reverse data flow back to source device 120, to prevent potential security risks like data exfiltration. Device 100 thus acts as a man-in-the-middle which emulates all of the operational attributes of sinks 122, 123 (e.g., power requirements, display configuration and settings, etc.) to sources 120, 121 during the handshaking process and all protocol interactions.

In some embodiments, upon connection of device 100 to sources 120, 121 and sinks 122, 123, controller 102 may perform an initial scan to identify the operational attributes of sinks 122, 123, including power requirements and display settings. Controller 102 may cache these identified operational attributes of sinks 122, 123, e.g., by storing this information on memory 104. Controller 102 may then simulate the power consumption needs of sinks 122, 123 to sources 120, 121 via a suitable communication to sources 120, 121, to ensure that sources 120, 121 provide power as if directly connected to sinks 122, 123. Controller 102 may then emulate sinks 122, 123 to sources 120, 121 based on the identified operational attributes of sinks 122, 123, to configured the data channels, including the main video channels and sideband use (SBU) pins. Controller 102 may then simulate to sources 120, 121 the EDID and related display configuration data of sinks 122, 123, including supported resolutions and refresh rates, color depth capabilities, audio formats, and timing parameters. If additional USB data channels are needed (e.g., alongside video), controller 102 may further simulate those to sources 120, 121. Once the handshaking process is completed, device 100 may carry unidirectional video/audio data from sources 120, 121 to intermediary device 100, which forwards it to sinks 122, 123. This process maintains compatibility with USB-C standards while enforcing security.

In some embodiments, device 100 is capable of detecting EDID settings of video sink devices 122, 123 and for communicating the EDID settings to source devices 120, 121. For example, upon initial connection, controller 102 may read the EDID data from video sink devices 122, 123, e.g., via the relevant pins in interfaces 112, 113. In some embodiments, this process may be a one-time EDID capture process performed upon initial connection. In some embodiments, device 100 may include a physical user-operated button configured to initiate the one-time acquisition of the EDID.

In some embodiments, controller 102 then parses and validates the EDID data, and stores it in memory 104. Controller 102 may then transmit the EDID data from memory 104 to source devices 120, 121. In some embodiments, this allows source devices 120, 121 to configure the video output optimally without direct, ongoing access to the EDID channel of video sink devices 122, 123.

In some embodiments, after the initial EDID capture, the relevant EDID connection pins in interfaces 112, 113 may be disconnected, isolated or blocked, to prevent further reads or writes. For example, in some embodiments, controller 102 and/or interfaces 112, 113 are configured to disconnect, block and/or disable any connection pins or lines which are configured to transmit data from sink devices 122, 123 to the source devices 120, 121. For example, when interfaces 112, 113 are an HDMI interface, interfaces 112, 113 and/or controller 102 are configured to disconnect and/or disable one or more pins within the HDMI interface that are configured to transmit data from sink devices 122, 123 to the source devices 120, 121. Such lines or pins may include the Display Data Channel (DDC) and/or the Consumer Electronics Control (CEC) channel. In other embodiments, interfaces 112, 113 are configured to transmit such signals from video display 122 through interfaces 112, 113 only to controller 102, while ensuring that such signals are not transmitted back to source devices 120, 121 through USB-C interfaces 106, 107. In yet other cases, the connection between interfaces 112, 113 and controller 102 may comprise a unidirectional component or circuit (e.g., a diode, or a fiber-optic connection) configured to enforce unidirectionality of data transmission only from controller 102 to interfaces 112, 113 to, but to disable data transmission in the reverse path.

As noted above, USB-C protocol supports alternate modes (alt-modes) for high-speed data transfer over a USB-C connection, which enables interoperability across multiple types of devices. A USB-C connection is established by connecting two devices via a USB Type-C cable. Because either one of the devices could potentially be a power supplier (source) or a power consumer (sink), the USB-C protocol provides for a configuration process over the configuration channels CC1/CC2, to determine the power and data parameters of the connection between the source device and the sink. The power delivery parameters are determined over the active configuration channel CC1/CC2, using the power delivery protocol (USB-PD), to set up the ongoing power sourcing and battery charging as applicable. Then, alt-mode can be initiated over the configuration channel CC1/CC2 lines, as defined by the USB-PD specification. Once alt-mode is initiated, the DisplayPort link negotiation begins over the sideband use channel SBU1/SBU2 lines, to set the parameters for the main link transmissions of DisplayPort data over the over TX1/RX1 and/or TX2/RX2 lines.

However, as noted above, data transmission between a source and a display over USB-C protocol is not secure, and thus presents a security risk. For example, a malicious code planted in the display can be transmitted back to the video source and infect it and potentially other devices in a network to which it may be connected.

In some embodiments, device 100 is configured to provide further security measures to protect the transmission of data between source devices 120, 121 and sink devices 122, 123. In some embodiments, controller 102 comprises one or more dedicated circuits and/or software agents configured to monitor data communication through device 100. Upon the occurrence of one or more conditions, controller 102 may be configured to disconnect and/or disable all data communication passing through device 100. In some embodiments, controller 102 may be further configured to shut down the USB-C connections to source devices 120, 121, by disabling power delivery channels, data channels, control channels, auxiliary channels, alt-mode protocols, and any combination thereof.

In some embodiments, controller 102 may be configured to continuously monitor the power delivery channels, data channels, control channels, auxiliary channels, alt-mode protocols of the USB-C connections between device 100 and source devices 120, 121. In some embodiments, upon detecting of suspicious malicious activity over the power delivery channels, data channels, control channels, auxiliary channels, alt-mode protocols of the USB-C connection, controller 102 may be configured to completely disable and/or disconnect any one or more of the USB-C interfaces 106, 107 and/or power delivery channels, data channels, control channels, auxiliary channels, alt-mode protocols, and any combination thereof with respect to the USB-C connection between device 100 and source devices 120, 121.

Accordingly, in some embodiments, device 100 of the present disclosure (in all variations and configurations) provides for secure transmission of video between a source and one or more sink devices over USB-C protocol.

In some embodiments, device 100 of the present disclosure (in all variations and configurations) provides for secure transmission of video (and embedded audio) between one or more sources and one or more sink devices, over USB-C protocol. In some embodiments, device 100 provides for one or more switching and selection mechanisms to allow users to select and switch between the various sources and the various sinks devices. In some embodiments, such switching and selection mechanisms may include on-screen display (OSD), i.e., a menu overlay on the monitor where users can use hotkeys or a mouse to browse and select available sources; physical buttons or a remote controls; a software or web interface using a mobile application or a browser-based dashboard; and the like.

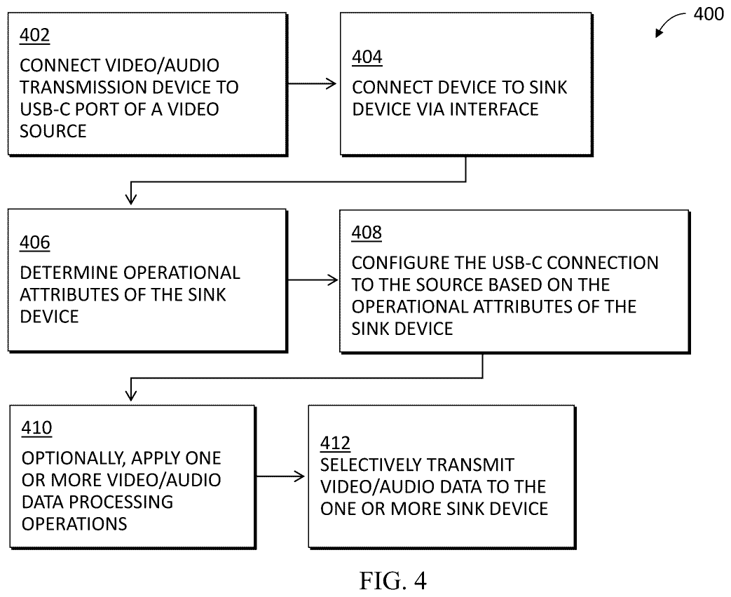

FIG. 4 illustrates the functional steps in a method 400 for secure transmission of video and/or audio data between one or more sources and one or more sink devices over USB-C protocol, using exemplary devices 100 (in all of its variations and configurations) as described with reference to FIGS. 3A-3C, according to some embodiments of the present disclosure.

The various steps of method 400 may either be performed in the order they are presented or in a different order (or even in parallel), as long as the order allows for a necessary input to a certain step to be obtained from an output of an earlier step. In addition, the steps of method 400 may be performed automatically (e.g., by a software agent running on device 100), unless specifically stated otherwise.

In step 402, device 100 is connected to a source device 120, such as a host computer. Where device 100 is realized as a dongle, device 100 may be connected directly at one end to a USB-C port of source device 120. In other cases, where device 100 is realized as a standalone computer hardware item comprising one or more cases or units, device 100 may be connected to a USB-C port of source device 120 via USB-C cables. In some embodiments, device 100 may be connected to the USB-C ports of source device 120 in either direction, i.e., the user can plug the connector into a receiving slot in either the ‘up’ or ‘down’ orientation in relation to the USB-C port.

In the case of the variation of device 100 shown in FIGS. 3B-3C, configured to support two or source devices, device 100 may be connected to two or more source devices 120, 121 via USB-C interfaces 106, 107, and the various steps of method 400 are performed with respect to both of source devices 120, 121, respectively.

Upon physical connection of device 100 to source 120, initial detection is performed via the configuration channels of USB-C interface 106, to indicate to source 120 that a USB-C device is attached. The initial detection process includes determining the respective roles of source 120 and device 100, as well as USB-C connector orientation (i.e., flip detection).

In step 404, device 100 may be connected to a sink device, such as display monitor 122, via a suitable connecting cable, such as an HDMI cable.

In the case of the variation of device 100 shown in FIGS. 3B-3C, configured to support two or more sink devices, device 100 may be connected to two or more sink devices 122, 123 via suitable connecting cables, such as HDMI cables, and the various steps of method 400 are performed with respect to both of sink devices 122, 123, respectively.

Upon physical connection of device 100 to sink 122, initial detection is performed to indicate to device 100 that sink 122 is attached. The initial detection process includes determining the respective roles of device 100 and sink 122.

In step 406, controller 102 performs an initial scan of sink 122 to identify the operational attributes of sink 122, including power requirements and display settings, including supported resolutions and refresh rates, color depth capabilities, audio formats, and timing parameters. Controller 102 may cache these identified operational attributes of sink 122, e.g., by storing this information on memory 104.

In step 408, controller 102 may initiate a configuration process (handshaking) of the USB-C connections to source device 120 over the configuration channels (CC1 and CC2), to determine functional parameters of the connection to permit transmission of video and audio signals via device 100 to sink device 122.

In some embodiments, controller 102 may be configured to simulate sink device 122 in order to configure the USB-C connection to source device 120, based, at least in part, on predetermined parameters that are hard-coded and stored within device 100, e.g., on memory 104. In some embodiments, the hard-coded parameters stored by device 100 may be protected from access and/or modification by users or any malicious attack.

In some embodiments, controller 102 may be configured to simulate sink device 122 in order to configure the USB-C connection to source device 120, based, at least in part, on the operational and/or functional requirements and operational attributes of sink device 122, as determined by controller 102 in step 406.

In some embodiments, controller 102 may be configured to simulate sink device 122 in order to configure the USB-C connection to source device 120, based, at least in part, on both predetermined parameters that are hard-coded and stored within device 100, e.g., on memory 104, and the operational and/or functional requirements and operational attributes of sink device 122, as determined by controller 102 in step 406.

In some embodiments, the handshaking process includes at least the following:
Connection detection and USB-C connector orientation.
USB power delivery (USB-PD) protocol negotiation with respect to power requirements.
DisplayPort Alternate Mode negotiation, including DisplayPort settings and data lanes configuration.

In some embodiments, the configuration of the USB-C connection to source device 120 may include determining power parameters for powering device 100 via the USB-C connection and/or for charging a rechargeable battery of device 100. The parameters for powering device 100 may include, but are not limited to, voltage, maximum current consumption, and the identities of the power source and the power sink.

In some embodiments, controller 102 configures the USB-C connection to source device 120 so as to enter a desired alt-mode communication standard of the USB-C protocol, such as DisplayPort. First, controller 102 may initiate the alt-mode of the USB-C connection is initiated through USB-PD over the configuration channel CC1/CC2CC lines. Once alt-mode is initiated, controller 102 may initiate the DisplayPort link negotiation process begins over the sideband use channel signals SBU1/SBU2 using DP-AUX protocol, as defined by the VESA DisplayPort over USB Type-C specification. In some embodiments, the negotiation process includes data transmission configuration (e.g., transmission speed and quality), display device requirements (EDID), and the like, as defined by the VESA DisplayPort main specification.

In step 410, controller 102 may optionally determine one or more processing operations to be applied to the video or audio data transmitted from source device 120 over the initiated alt-mode protocol. For example, controller 102 may operate signal processor 108 to process the video data transmission in any desired or suitable manner, such as by converting the DisplayPort protocol data to HDMI protocol data, or to any other suitable video protocol.

In step 412, controller 102 initiates secure video (which may include embedded audio) data transmission from source device 120 via USB-C interface 106 to sink device 122, 123.

In the case of the variations of device 100 shown in FIG. 3AB-3C, configured to support two or more sink devices 122, 123, device 100 may be operated to selectively transmit the video data transmission signal to a selected one of interfaces 112, 113 connected to sink devices 122, 123, respectively, e.g., based on user selection, as described above.

In a second aspect of the present invention, a secure keyboard, video and mouse (KVM) switch is disclosed. In some embodiments, the secure KVM of the present disclosure provides for selectively controlling two or more host computers from a single user console comprising a display device (e.g., a display monitor) and control peripherals, such as a keyboard and/or pointing device (e.g., a mouse).

As noted above, controlling multiple host computers from a single central user console can raise security challenges, because shared displays and control peripherals may be targets for malicious attacks which attempt to cause data leakage between the separate host computers. One possible solution is to enforce unidirectionality of data transmission between the host computers and each of the user control and display peripherals (e.g., unidirectional video streaming from host to display, and unidirectional data from keyboard and mouse to the host computer), thus minimizing the risk of data leakage between host computers.

However, one of the challenges is the fact that different display monitors may require different video transmission settings to enable optimal operation of the display. Thus, connecting a display to a host computer typically requires transmitting EDID settings data from the display to the computer, to enable the host computer to adjust its video stream output to the monitor's settings. The transmission of EDID settings tables from the display monitor to the host computer thus requires at least some bi-directional data transmission between the user control and display peripherals and the multiple host computers.

This reality presents a risk is that a connected host computer may be hacked and used to transmit malicious code through the bi-directional EDID data line back to the shared display. Then, when the display is switched to another host computer, the data that was maliciously stored on the display may be transferred to a another host computer.

Accordingly, the present disclosure provides for a secure KVM device coupled between one or more host computers and a single user console comprising a display and control peripherals, such as keyboard and/or mouse, for selectively controlling a selected one of the host computers. In some embodiments, the present device provides for secure unidirectional transmission of control inputs only from the keyboard and mouse to the selected host computer, and for secure unidirectional transmission of video data only from the selected host computer to the display.

In some embodiments, the present disclosure provides for a secure KVM device coupled between one or more host computers and a single user console comprising a display and control peripherals, such as keyboard and/or mouse, for selectively controlling a selected one of the host computers. In some embodiments, the present device provides for emulating control inputs from the keyboard and mouse to the selected host computer, while blocking any direct or pass-through data communication, and for secure unidirectional transmission of video data only from the selected host computer to the display.

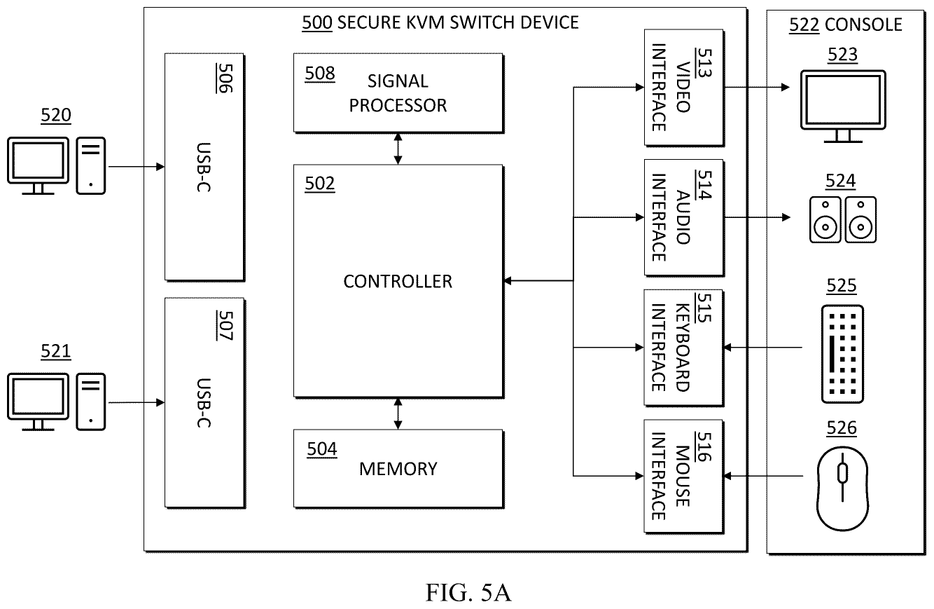

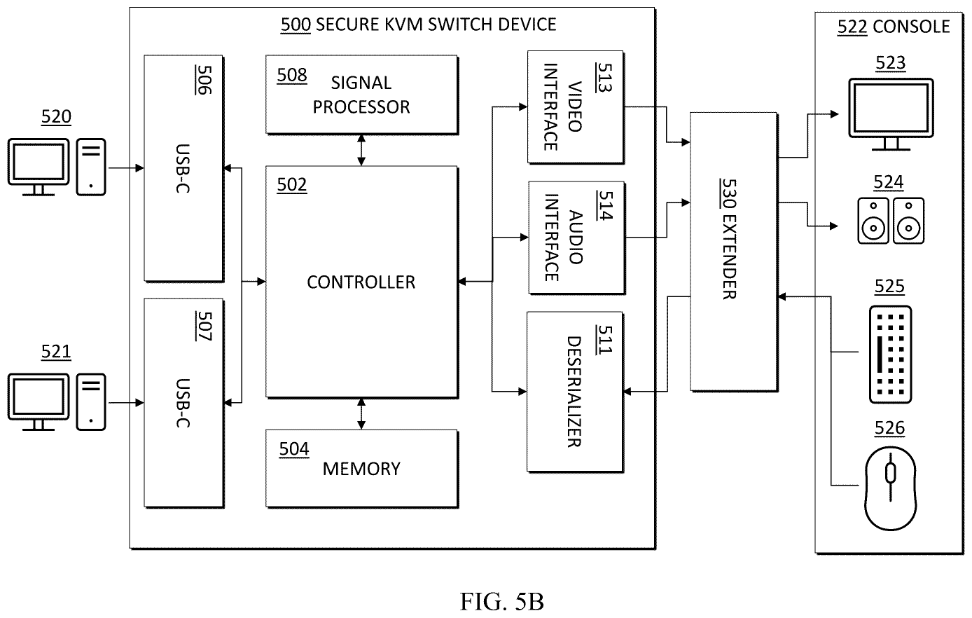

FIG. 5A shows secure KVM switch device 500 of the present disclosure. In some embodiments, device 500 is coupled between two or more host computers 520, 521 and one or more user consoles 522. Each user console 522 comprises typically one or more display monitors 523, and peripheral devices such as an audio device (e.g., speakers, headphones, etc.) 524, and control devices, such as a keyboard 525, and/or a pointing device (mouse) 526. In some embodiments, console 522 may comprise additional or different peripherals, such as a webcam (not shown). In some embodiments, pointing device 526 can be any device such as a mouse, graphics tablet, stylus, pointing-stick, touch-pad, trackball, and the like, used to control the movements of a cursor on a computer screen.

The embodiment of device 500 shown in FIG. 5A is configured for switching a user console 522 comprising, e.g., a display 523, audio device 524, and peripheral controls 525, 526, between two host computers 520, 521. However, the components and principles of operation as shall be described hereinbelow likewise apply to any one-to-many or many-to-many potential embodiments of device 500, comprising one or more user consoles 522 which may be switched among two or more host computers.

Device 500 as described herein is only an exemplary embodiment of the present invention, and in practice may be implemented in hardware only or a combination of both hardware and software. Device 500 is described herein for illustrative purposes with an exemplary set of modules and components performing various functionalities within device 500. However, in practice, device 500 may have more or fewer components and modules than shown, may combine two or more of the components or modules, or may have a different configuration or arrangement of the components or modules. Device 500 may include any additional component enabling it to function such as a motherboard, data busses, power supply, a network interface card, etc. (not shown).

In some embodiments, device 500 may store in memory 504 software instructions or components configured to operate device 500. The software instructions may be any executable code, e.g., a software application, a program, a process, task or script. In some embodiments, the software instructions may include an operating system, including various software components and/or drivers for controlling and managing general system tasks (e.g., memory management, storage device control, power management, etc.) and facilitating communication between various hardware and software components.

Device 500 in this embodiment may be realized as a standalone computer hardware item comprising one or more cases or units, which connects to host computers 520, 521 via respective USB-C cables. However, other suitable configurations of device 500 may be realized, as is known in the art.

In some embodiments, device 500 may receive power for its operation from one or more of host computers 520, 521, via the USB-C connection. In other cases, device 500 may be powered independently of the host computers, e.g., using a standard wall outlet. In some embodiments, device 500 may be battery-powered by a rechargeable battery which may be recharged via the USB-C connection to the host computers.

Device 500 in this configuration comprises at least the following components, modules and/or functionalities:
Controller 502.
Memory 504.
USB-C interfaces 506, 507.
Signal processor 508.
Video interface 513.
Peripheral interfaces:
   Audio interface 514.
   Keyboard Interface 515.
   Mouse Interface 516.

In some embodiments, the peripheral interfaces, e.g., audio interface 514, keyboard interface 515, and mouse interface 516, may comprise any suitable port, such as USB-A ports, for connecting physical peripherals (keyboard, mouse, headset, etc.).

The enumerated peripheral interfaces are shown for exemplary purposes only, and in practice may include more or different peripheral ports, such as a webcam connection. However, the principles of operation of device 500 as described herein are equally applicable to any number and/or different types of peripheral devices.

In some embodiments, device 500 further includes user-operable switching and selection mechanisms, to allow users to select and switch between host computers 520, 521. In some embodiments, such switching and selection mechanisms may include physical buttons or a remote control; on-screen display (OSD), i.e., a menu overlay on the monitor where users can use hotkeys or a mouse to browse and select available sources; a software or web interface using a mobile application or a browser-based dashboard; and the like.

Controller 502 serves as the central processing and coordination hub of device 500 and controls the operation of device 500. Controller 502 is operationally connected to and acts as the primary interface between all hardware and software components of device 502, including memory 504; USB-C interfaces 506, 507; signal processor 508; and interfaces 513, 514, 515, 516.

Controller 502 manages the complete data flow throughout device 500 and acts as an internal switching module which routes and manages data flow between the other modules and components. In some embodiments, controller 502 is connected to and receives at least one or more of the following channels of USB-C interface 506, 507:
High-speed data channels transmitted over transmitter (TX) and receiver (RX) differential pairs, TX1/RX1 and/or TX2/RX2 lines, which form unidirectional, high-bandwidth channels used to transport video and audio signals.
Data lines D+and D-which carry differential signals for lower-speed USB 2.0 data, such as like keyboards and mouse.
Configuration channels CC1/CC2, used to detect connection orientation in relation to the USB-C port, power delivery, and channel configuration.
Sideband use channel that transmits the sideband use channel signals SBU1/SBU2, which enable multi-purpose alternate modes (alt-mod) supported by the USB-C protocol.

Memory 504 may comprise a read-only erasable and programable memory (EEPROM) unit.

One or more USB Type-C interfaces (e.g., interfaces 506, 507), are each connectable to a USB-C port of any suitable device, such as host computers 520, 521, directly or via any suitable connecting means, such as a USB-C cable. In some embodiments, USB-C interfaces 506, 507 include a USB hub and/or controller which manages the operation of USB-C interfaces 506, 507

Signal processor 508 may be configured to process video and/or audio data transmission using any desired or suitable processing method or algorithm, such as by converting DisplayPort protocol data to HDMI protocol data, or to any other suitable video protocol.

Keyboard interface 515 and/or mouse interface 516 are configured to receive standard bidirectional peripheral control commands from keyboard 525 and/or mouse 526.

In one embodiment, keyboard interface 515 and/or mouse interface 516 are then configured to transmit these commands to controller 502, for communicating these control commands to host computers 520, 521. In some embodiments, keyboard interface 515 and/or mouse interface 516 are configured to receive standard bidirectional peripheral control commands from keyboard 525 and/or mouse 526, and to transmit these commands using a unidirectional transmission protocol and/or connection. For example, the connection between keyboard interface 515 and/or mouse interface 516 and controller 502 may comprise a unidirectional component or circuit (e.g., a diode, or a fiber-optic connection) configured to enforce unidirectionality of data transmission only from keyboard 525 and/or mouse 526 to controller 502, but to prevent any data transmission in the reverse path, back to keyboard 525 and/or mouse 526.

Controller 502 may be configured to receive the standard bidirectional peripheral control commands from keyboard interface 515 and/or mouse interface 516, and to apply further processing in any suitable manner, such as by applying any proprietary or industry-standard protocol, e.g., UART (Universal Asynchronous Receiver/Transmitter) communication protocol.

In another embodiments, keyboard interface 515 and/or mouse interface 516 are then configured to transmit these commands to controller 502. Controller 502 may be configured to simulate to host computers 520, 521 the peripheral controls (keyboard 525 and/or mouse 526), i.e., cause device 500 to present itself to the host computers as a composite USB device that mimics the identified peripherals keyboard 525 and/or mouse 526, while preventing direct or pass-through data transmission from the keyboard 525 and/or mouse 526 to the host computers, as well as preventing any data transmission from the host computers to keyboard 525 and/or mouse 526.

In some embodiments, video interface 513 is connectable to display device 523. Video interface 513 may be a DisplayPort interface, a Thunderbolt 3 interface, an HDMI (High-Definition Multimedia interface) interface, or any other suitable or desirable video connection, without limitation.

In some embodiments, video interface 513 is configured to only permit video and audio data transmission from host computers 520, 521 to video display device 523 through device 500, and to prevent any data originating from video display 523 to be transmitted back to host computers 520, 521 via device 500.

In some embodiments, device 500, e.g., via controller 502, is configured to perform the USB-C handshake process with host computers 520, 521, to facilitate control of host computers 520, 521 via console 522. In some embodiments, device 500 is configured to only permit video and audio data transmission from a selected one of host computers 520, 521 to console 522, and to prevent any data originating from console 522 to be transmitted back to host computers 520, 521. Thus, device 500 is configured to block any reverse data flow back to host computers 520, 521, to prevent potential security risks like data exfiltration. Device 500 thus acts as a man-in-the-middle which emulates all of the operational attributes of the various components of console 522 to host computers 520, 521 during the handshaking process and all protocol interactions.

In some embodiments, upon connection of device 500 to host computers 520, 521 and the components of console 522 (i.e., display monitor 523, audio device 524, keyboard 525, and/or mouse 526), controller 502 may perform an initial scan to identify any relevant operational attributes of the components of console 522, including power requirements and display 523 settings.

For example, display operational attributes may include the EDID information of the actual display, including supported resolutions, refresh rates, color depths, and timing parameters.

For example, keyboard operational attributes may include USB descriptor information (vendor ID, product ID, capabilities), polling rate (typically 125 Hz to 1000 Hz for gaming keyboards), key rollover capability (6 KRG, NKRO), scan code timing and bounce characteristics, special function keys and media controls, and/or backlight control protocols if applicable.

For pointing devices (e.g., a mouse), operational attributes may include polling rate (125 Hz to 8000 Hz for high-end gaming mice), DPI settings and switching behavior, number of buttons and their mappings, acceleration curves and sensor characteristics, and/or scroll wheel resolution and behavior.

Controller 502 may cache these identified operational attributes, e.g., by storing this information on memory 504.

Controller 502 may then simulate these operational attributes to host computers 520, 521, to configure the power delivery, data channels, and display settings (EDID) of the USB-C connections to host computers 520, 521.

Controller 502 may further simulate to host computers 520, 521 the EDID and related display configuration data of display 523, including supported resolutions and refresh rates, color depth capabilities, audio formats, and timing parameters.

Controller 502 may further simulate to host computers 520, 521 additional USB data channels that are needed for audio device 524, keyboard 525, and/or mouse 526. Controller 502 may further simulate to host computers 520, 521 the peripheral controls (audio device 524, keyboard 525 and/or mouse 526), i.e., cause device 500 to present itself to the host computers as a composite USB device that mimics the identified peripherals audio device 524, keyboard 525 and/or mouse 526, while preventing direct or pass-through data transmission from the audio device 524, keyboard 525 and/or mouse 526 to the host computers, as well as preventing any data transmission from the host computers to keyboard 525 and/or mouse 526.

In some embodiments, interface 513 is configured to receive data from display device 523 that is designed to be transmitted from display device 523 to the host computers 520, 521, because it may be required or necessary for the optimal operation of display device 523. Such data lines or pins may include the Display Data Channel (DDC) and/or the Consumer Electronics Control (CEC) channel. In such cases, controller 502 may be configured to receive and store such data, e.g., in memory 504, and to prevent any such data originating from video display 523 to be transmitted back to host computers 520, 521. Thus, for example, controller 502 may be configured to receive and store DDC settings received from display device 523 in memory 504. Controller 502, for example, may then use such data to determine the required video settings for display device 523, and to transmit appropriate instructions (which may be stored in a separate predetermined settings table on memory 504) to host computers 520, 521, so also to enable host computers 520, 521 to adjust a video output in accordance with the technical specifications of display device 523.

For example, in some embodiments, device 500 is capable of detecting EDID settings of display 523. For example, upon initial connection, device 500 may read the EDID data from display 523, e.g., via the relevant pins in the video interface 513. In some embodiments, this process may be a one-time EDID capture process performed upon initial connection. In some embodiments, device 500 may include a physical user-operated button configured to initiate the one-time acquisition of the EDID.

In some embodiments, device 500 then parses and validates the EDID data, and stores in memory 504. Device 500 may then transmits the EDID data from memory 504 to host computers 520, 521. In some embodiments, this allows host computers 520, 521 to configure the video output optimally without direct, ongoing access to the EDID channel of display 523.

In some embodiments, after the one-time EDID capture process and during normal operation thereafter, interface 513 is configured to disconnect, block and/or disable one or more pins within interface 513 that are configured to transmit data from display 523 to the host computers 520, 521. For example, such lines or pins may include the Display Data Channel (DDC) and/or the Consumer Electronics Control (CEC) channel in HDMI interfaces. In other embodiments, interface 513 is configured to allow transmission of these signals from display 523 through interface 513 only to controller 502, while ensuring that such signals are not transmitted back to host computers 520, 521. In yet other cases, the connection between interface 513 and controller 502 may comprise a unidirectional component or circuit (e.g., a diode, or a fiber-optic connection) configured to enforce unidirectionality of data transmission only from controller 502 to interface 513, but to disable data transmission in the reverse path.

In some embodiments, audio interface 514 is connectable to audio device 524. Audio interface 514 may comprise any audio output port or connector used for connecting audio devices such as headphones, speakers, amplifiers, DACs, or sound systems. Audio interface 514 may also comprise circuitry configured for handling analog-to-digital (ADC) and/or digital-to-analog (DAC) conversion.

In a variation of device 500 shown in FIG. 5B, user console 522, comprising display 523, audio device 524, keyboard 525 and/or mouse 526 may be located remotely, to allow a user to control one or more host computers 520, 521 from a distant location, such as another room, building, etc. In these configurations, Device 500 may be placed near host computers 520, 521, and interface directly with host computers 520, 521 via USB-C connections. At the same time, display 523, audio device 524, keyboard 525 and/or mouse 526 may be located remotely and connect to device 500 via a remote extender 530, which handles the communications between console 522 and device 500. However, in some cases, an extender 530 may be used to handle the communications between console 522 and device 500 even if device 500 and console 522 are located in close proximity or in the same room, where direct connection may also be possible.

Extender 530 typically employs high-speed data transmission links, such as fiber optic cables, with separate channels for different data directions: ‘downstream’ video transmission from device 500 to display 523 and/or audio device 524, and ‘upstream’ from keyboard 525 and/or mouse 526 to device 500. The downstream data path is typically a high-bandwidth video (which may include embedded audio) as well as audio channels, which uses a unidirectional fiber optic.

The upstream data path (from keyboard 525 and/or mouse 526 to device 500) is typically a low-bandwidth channel for control signals from keyboard and/or mouse that are captured at the remote console 522, serialized, and sent back to the device 500 for transmission into the device 500. To enable long-distance transmission without signal degradation, a unidirectional fiber optic setup with SERDES (Serializer/Deserializer) may be employed. This configuration uses a single fiber strand dedicated to one-way traffic (keyboard 525 and/or mouse 526 to device 500). The input data is captured at console 522 from keyboard 525 and/or mouse 526, packetized, and converted into a serial bitstream for remote transmission. Once received at device 500, the data is converted back to parallel data by deserializer 511, and is transmitted to controller 502, which uses it to emulate the inputs of keyboard 525 and/or mouse 526 for transmission to host computers 520, 521 via USB-C interfaces 506, 507.

In some embodiments, device 500 is configured to provide further security measures to protect the transmission of data between host computers 520, 521 and console 522. In some embodiments, controller 502 comprises one or more dedicated circuits and/or software agents configured to monitor that data communication through device 500 and upon the occurrence of one or more conditions, controller 502 may be configured to disconnect and/or disable all data communication passing through device 500. In some embodiments, controller 502 may be further configured to shut down the USB-C connection to host computers 520, 521, by disabling power delivery channels, data channels, control channels, auxiliary channels, alt-mode protocols, and any combination thereof.

In some embodiments, controller 502 may be configured to continuously monitor the power delivery channels, data channels, control channels, auxiliary channels, alt-mode protocols of the USB-C connection between device 500 and host computers 520, 521. In some embodiments, upon detecting of suspicious malicious activity over the power delivery channels, data channels, control channels, auxiliary channels, alt-mode protocols of the USB-C connection, controller 502 may be configured to completely disable and/or disconnect any one or more of the USB-C interfaces 506, 507 and/or power delivery channels, data channels, control channels, auxiliary channels, alt-mode protocols, and any combination thereof with respect to the USB-C connection between device 500 and host computers 520, 521.

Accordingly, in some embodiments, device 500 of the present disclosure (in all variations and configurations) provides a secure KVM for selectively controlling two or more host computers 520, 521 from a single user console comprising a display device 523, audio device 524, a keyboard 525, and/or a pointing device 526 (e.g., a mouse).

In some embodiments, device 500 is configured to receive from keyboard 525 and pointing device 526 control commands and selectively and unidirectionally transmit the control commands to a selected host computer of host computers 520, 521, while ensuring that data is not transmitted in the opposite direction, from the selected host computer to keyboard 525 and pointing device 526; and to receive video and/or audio data from the selected host computer of host computers 520, 521 and to transmit the video data to display device 523 and/or audio device 524, while ensuring that data is not transmitted in the opposite direction, from display device 523 and/or audio device 524 to the selected host computer.

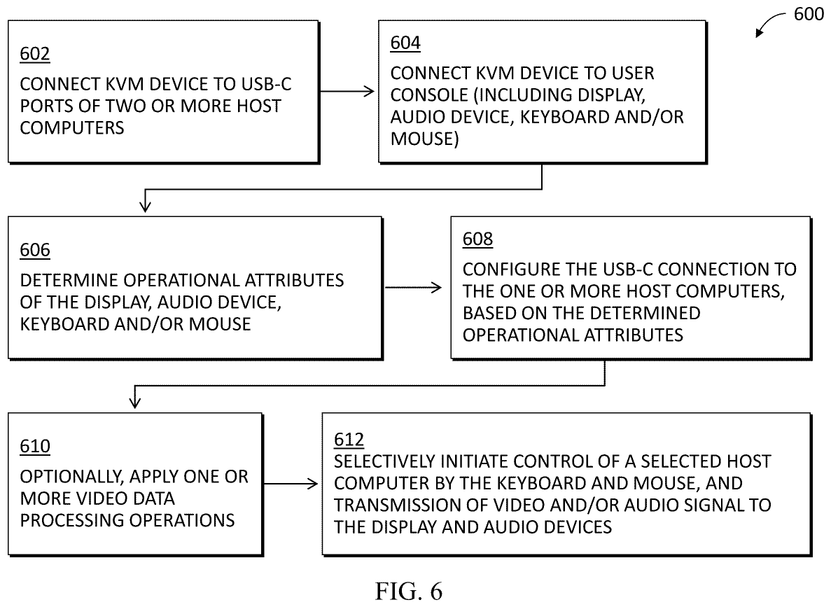

FIG. 6 illustrates the functional steps in a method 600 for securely selectively controlling two or more host computers from a single user console comprising a keyboard, a pointing device (e.g., a mouse), and a display device (e.g., a display monitor). The steps of method 600 will be described with continuous reference to device 500 shown in FIGS. 5A-5B.

The various steps of method 600 may either be performed in the order they are presented or in a different order (or even in parallel), as long as the order allows for a necessary input to a certain step to be obtained from an output of an earlier step. In addition, the steps of method 600 may be performed automatically (e.g., by a software agent running on device 500), unless specifically stated otherwise.

In step 602, device 500 is connected to two or more host computers 520, 521. For example, device 500 may be connected to respective USB-C ports of host computers 520, 521 via suitable USB-C cables. In some embodiments, device 500 may be connected to the respective USB-C ports of host computers 520, 521 in either direction, i.e., the user can plug the connector into a receiving slot in either the ‘up’ or ‘down’ orientation in relation to the USB-C port.

Upon physical connection of device 500 to host computers 520, 521, initial detection is performed via the configuration channels of USB-C interface 506, 507, to indicate to host computers 520, 521 that a USB-C device is attached. The initial detection process includes determining the respective roles of host computers 520, 521 and device 500, as well as USB-C connector orientation (i.e., flip detection).

In some embodiments, controller 502 detects a specific signal from the one or more host computers 520, 521 indicating that one or more host computers 520, 521 are connected to device 500 via USB-C interfaces 506, 507. Controller 502 detects a specific signal from the host computers 520, 521 indicating that one or more host computers 520, 521 are connected to device 500 via USB-C interfaces 506, 507, wherein the signal may be transmitted from host computers 520, 521 via USB-C interfaces 506, 507 to controller 502. In some embodiments, based on the detected signal, controller 502 deems one or more host computers 520, 521 to be connected to device 500.

In step 604, device 500 may be connected to user console 522 by:
Connecting display monitor 523 to video interface 513 via a suitable video connecting cable, such as an HDMI cable.
Connecting audio device 524 to audio interface 514 via a suitable connecting cable.
Connecting keyboard 525 to keyboard interface 515 via a suitable connecting cable, e.g., a USB connecting cable.
Connecting pointing device (mouse) 526 to mouse interface 516 via a suitable connecting cable, e.g., a USB connecting cable.

In a variation with reference to FIG. 5B, device 500 may be connected to user console 522 which is located remotely, via an extender 530, which handles the communications between console 522 and device 500.

Upon physical connection of device 500 to the various components of console 522, initial detection is performed to indicate to device 500 that the various components of console 522 are attached. The initial detection process includes determining the respective roles of device 500 and each of the various components of console 522.

In some embodiments, controller 502 detects one or more specific signals originating from display device 523, audio device 524, keyboard 525, and/or mouse 526, as the case may be, such as hot plug detect signal (HPD), auxiliary channel signals AUX+/−, DDC channel signals, and/or any other signal which may be transmitted from a display and control peripherals to host computers to enable a functional connection between the host computers and the display and control peripherals. In some embodiments, these one or more signals originating from display device 523, audio device 524, keyboard 525, and/or mouse 526, as the case may be, may be transmitted via video interface 513, audio interface 514, keyboard interface 515, and/or mouse interface 516, respectively, to controller 502. In the variation of FIG. 5B, the signals originating from display device 523, audio device 524, keyboard 525, and/or mouse 526 may be received from remote console 522 via extender 530. In some embodiments, based on the detected signals, controller 502 may deem display device 523, audio device 524, keyboard 525, and/or mouse 526, as the case may be, to be connected to device 500.

In step 606, controller 502 may perform an initial scan of the various components of console 522 to identify the operational attributes of the various components of console 522, including power requirements and display settings, including supported resolutions and refresh rates, color depth capabilities, audio formats, and timing parameters. Controller 502 may cache these identified operational attributes of the various components of console 522, e.g., by storing this information on memory 504.

For example, display 523 operational attributes may include the EDID information of the actual display, including supported resolutions, refresh rates, color depths, and timing parameters. In some embodiments, device 500 detects EDID settings of display 523. For example, device 500 may read the EDID data from display 523, e.g., via the relevant pins in the video interface. In some embodiments, this process may be a one-time EDID capture process performed upon initial connection. In some embodiments, device 500 may include a physical user-operated button configured to initiate the one-time acquisition of the EDID. In some embodiments, device 500 then parses and validates the EDID data, and stores in memory 504.

For example, audio device 524 operational attributes may include sample rates and number of channels.

For example, keyboard 525 operational attributes may include USB descriptor information (vendor ID, product ID, capabilities), polling rate (typically 125 Hz to 1000 Hz for gaming keyboards), key rollover capability (6 KRG, NKRO), scan code timing and bounce characteristics, special function keys and media controls, and/or backlight control protocols if applicable.

For mouse 526 operational attributes may include polling rate (125 Hz to 8000 Hz for high-end gaming mice), DPI settings and switching behavior, number of buttons and their mappings, acceleration curves and sensor characteristics, and/or scroll wheel resolution and behavior.

In step 608, controller 502 may initiate a configuration process (handshaking) of the USB-C connections to host computers 520, 521 over the configuration channels (CC1 and CC2), to determine functional parameters of the connection to permit transmission of:
Video and audio signals from a selected one of host computers 520, 521 to display device 523 and/or audio device 524.
Peripheral control commands from keyboard 525 and/or mouse 526, via keyboard interface 515 and/or mouse interface 516 and USB-C interfaces 506, 507, respectively, to a selected one of host computers 520, 521.

In some embodiments, the configuration process of the USB-C connections to host computers 520, 521 may include ensuring that the USB-C connections are able to handle the aggregate bandwidth requirements of all simulated peripherals. In addition,, the configuration process of the USB-C connections to host computers 520, 521 may include providing all peripheral devices descriptors and operational attributes.

In some embodiments, controller 502 may be configured to simulate the various components of console 522 to host computers 520, 521, based, at least in part, on predetermined parameters that are hard-coded and stored within device 500, e.g., on memory 504. In some embodiments, the hard-coded parameters stored by device 500 may be protected from access and/or modification by users or any malicious attack.

In some embodiments, controller 502 may be configured to simulate the various components of console 522 to host computers 520, 521, based, at least in part, on the operational and/or functional requirements and attributes associated with display device 523, audio device 524, keyboard 525, and/or mouse 526, as determined by controller 502 in step 606.

In some embodiments, controller 502 may be configured to simulate the various components of console 522 to host computers 520, 521, based, at least in part, on the both predetermined parameters that are hard-coded and stored within device 500, e.g., on memory 504, and the operational and/or functional requirements and parameters associated with display device 523, audio device 524, keyboard 525, and/or mouse 526, as determined by controller 502 in step 606.

In some embodiments, controller 502 configures the USB-C connection to host computers 520, 521, including by determining at least the following functional parameters:
Connection detection and USB-C connector orientation.
USB power delivery (USB-PD) protocol negotiation with respect to power requirements.
DisplayPort Alternate Mode negotiation, including DisplayPort settings and data lanes configuration.
Audio device configuration, including audio format (sample rate, bit depth, channels).
Keyboard configuration.
Mouse configuration.

In some embodiments, the configuration of the USB-C connection to host computers 520, 521 may include determining power parameters for powering device 500 via the USB-C connection and/or for charging a rechargeable battery of device 500. The parameters for powering device 500 may include, but are not limited to, voltage, maximum current consumption, and the identities of the power source and the power sink.

At the conclusion of step 608, device 500 is connected to host computers 520, 521 via a USB-C interface, wherein device 500 simulates display device 523, audio device 524, keyboard 525, and/or mouse 526.

In some embodiments, controller 502 configures the USB-C connection to host computers 520, 521 so as to enter a desired alt-mode communication standard of the USB-C protocol, such as DisplayPort. First, controller 502 may initiate the alt-mode of the USB-C connection is initiated through USB-PD over the configuration channel CC1/CC2CC lines. Once alt-mode is initiated, controller 502 may initiate the DisplayPort link negotiation process begins over the sideband use channel signals SBU1/SBU2 using DP-AUX protocol, as defined by the VESA DisplayPort over USB Type-C specification. In some embodiments, the negotiation process includes data transmission configuration (e.g., transmission speed and quality), display device requirements (EDID), and the like, as defined by the VESA DisplayPort main specification.

This configuration process is carried out by controller 502, simulating a sink device, with host computers 520, 521 to establish communication link according to a desired interface standard, such as DisplayPort. The specific steps in the configuration process handshaking process by controller 502 are determined by the specific interface standard selected, as is well known in the art.

In step 610, controller 502 may optionally determine one or more processing operations to be applied to the video data transmitted from host computers 520, 521 over the initiated alt-mode protocol. For example, controller 502 may operate signal processor 508 to process the video data transmission in any desired or suitable manner, such as by converting the DisplayPort protocol data to HDMI protocol data, or to any other suitable video protocol.

In step 612, controller 502 initiates control of a selected one of host computers 520, 521 (e.g., based on user selection) via user console 522 comprising display device 523, audio device 524, keyboard 525, and/or mouse 526.

In some embodiments, controller 502 initiates control of a selected one of host computers 520, 521 (e.g., based on user selection) by transmitting peripheral control commands from keyboard 525 and/or mouse 526, via keyboard interface 515 and/or mouse interface 516, respectively, and a respective one of USB-C interfaces 506, 507.

In some embodiments, controller 502 initiates video data transmission from the selected one of host computers 520, 521 via a respective one of USB-C interfaces 506, 507, optionally signal processor 508, and video interface 513, to display device 523. In some embodiments, controller 502 initiates audio transmission from the selected one of host computers 520, 521 via a respective one of USB-C interfaces 506, 507 and audio interface 514, to audio device 524.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter is not limited to the particular embodiment disclosed as the best mode contemplated for carrying out this invention, but only by the claims that follow.

1. A secure KVM device, comprising:
two or more USB-C interfaces configured to connect to respective USB-C ports of two or more host computers;
a device interface configured to connect to a user console comprising a display and control peripherals; and
a controller,
wherein said controller is configured to identify the operational attributes of said display and control peripherals,
wherein said controller is configured to initiate, based on user selection, control by said user console of a selected host computer of said two or more host computers,
wherein said controller is configured to perform a configuration process of a USB-C connection with said selected host computer, to determine operational parameters of said USB-C connection, based, at least in part, on said identified operational attributes of said display and control peripherals,
wherein based, at least in part, on said configuration process, said secure KVM device is configured to transmit control commands received from said control peripherals via said device interface, to said selected host computer over said USB-C connection, while enforcing unidirectionality which prevents transmission of data from said selected host computer to said control peripherals, and
wherein based, at least in part, on said configuration process, said secure KVM device is configured to transmit a video signal received from said selected host computer via said USB-C connection, to said display via said device interface, while enforcing unidirectionality which prevents transmission of data from said display to said selected host computer.

2. The secure KVM device of claim 1, wherein said secure KVM device is configured to simulate said display and control peripherals to said selected host computer, based, at least in part, on said identified operational attributes of said display and control peripherals.

3. The secure KVM device of claim 1, wherein said configuration process of said USB-C connection configures said USB-C connection to handle at least the following protocols simultaneously: (i) DisplayPort Alt Mode protocol for said transmitting of said video signal from said selected host computer to said display, and (ii) USB data channels for said transmitting of said control commands from said control peripherals to said selected host computer.

4. The secure KVM device of claim 1, wherein said configuration process of said USB-C connection comprises at least: (i) connection detection and determination of USB-C connector orientation, (ii) power delivery protocol negotiation with respect to power requirements, and (iii) USB-C Alternate Mode negotiation including DisplayPort settings and data lanes configuration.

5. The secure KVM device of claim 4, wherein said DisplayPort settings comprise Extended Display Identification Data (EDID) information of said display, comprising resolution, refresh rates, color depth, and/or supported timing.

6. The secure KVM device of claim 1, wherein said control peripherals comprise at least a keyboard and a pointing device.

7. The secure KVM device of claim 1, further comprising a memory storage, wherein said controller is configured to store said identified operational attributes of said display and control peripherals in said memory storage.

8. The secure KVM device of claim 1, wherein said user console further comprises an audio device, and wherein said secure KVM device is configured to transmit an audio signal received from said selected host computer over said USB-C connection, to said audio device via said device interface, while enforcing unidirectionality which prevents transmission of data from said audio device to said selected host computer.

9. The secure KVM device of claim 1, wherein said device interface comprises at least a video interface and one control peripheral interface.

10. The secure KVM device of claim 1, wherein said user console is connected to said secure KVM device via an extender comprising a downstream data channel for said video signal and an upstream data channel for said control commands.

11. A method comprising:
providing a secure KVM device comprising:
two or more USB-C interfaces configured to connect to respective USB-C ports of two or more host computers,
a device interface configured to connect to a user console comprising a display and control peripherals, and
a controller;
connecting said two or more USB-C interfaces to said respective USB-C ports of said two or more host computers;
connecting said user console to said device interface;
identifying, by said controller, operational attributes of said display and control peripherals;
initiating, by said controller, based on user selection, control by said user console of a selected host computer of said two or more host computers;
performing, by said controller, a configuration process of a USB-C connection with said selected host computer, to determine operational parameters of said USB-C connection, based, at least in part, on said identified operational attributes of said display and control peripherals;
transmitting by said secure KVM device control commands received from said control peripherals via said device interface, to said selected host computer over said USB-C connection, while enforcing unidirectionality which prevents transmission of data from said selected host computer to said control peripherals; and
transmitting by said secure KVM device a video signal received from said selected host computer via said USB-C connection, to said display via said device interface, while enforcing unidirectionality which prevents transmission of data from said display to said selected host computer.

12. The method of claim 11, wherein said secure KVM device is configured to simulate said display and control peripherals to said selected host computer, based, at least in part, on said identified operational attributes of said display and control peripherals.

13. The method of claim 11, wherein said configuration process of said USB-C connection configures said USB-C connection to handle at least the following protocols simultaneously: (i) DisplayPort Alt Mode protocol for said transmitting of said video signal from said selected host computer to said display, and (ii) USB data channels for said transmitting of said control commands from said control peripherals to said selected host computer.

14. The method of claim 11, wherein said configuration process of said USB-C connection comprises at least: (i) connection detection and determination of USB-C connector orientation, (ii) power delivery protocol negotiation with respect to power requirements, and (iii) USB-C Alternate Mode negotiation including DisplayPort settings and data lanes configuration.

15. The method of claim 14, wherein said DisplayPort settings comprise Extended Display Identification Data (EDID) information of said display, comprising resolution, refresh rates, color depth, and/or supported timing.

16. The method of claim 11, wherein said control peripherals comprise at least a keyboard and a pointing device.

17. The method of claim 11, wherein said secure KVM device further comprises a memory storage, said method further comprising storing, buy said controller, said identified operational attributes of said display and control peripherals in said memory storage.

18. The method of claim 11, wherein said user console further comprises an audio device, said method further comprising transmitting by said secure KVM device an audio signal received from said selected host computer over said USB-C connection, to said audio device via said device interface, while enforcing unidirectionality which prevents transmission of data from said audio device to said selected host computer.

19. The method of claim 11, wherein said device interface comprises at least a video interface and one control peripheral interface, said method further comprising connecting said display to said video interface and connecting at least a first one of said control peripherals to said control peripheral interface.

20. The method of claim 11, wherein said user console is connected to said secure KVM device via an extender comprising a downstream data channel for said video signal and an upstream data channel for said control commands, said method further comprising connecting said display and said control peripherals to said extender.
